(19) United States
(12) Patent Application Publication
(10) Pub. No.: US 2022/0219328 A1
(43) Pub. Date: Jul. 14, 2022

(54) METHOD AND DEVICE FOR CREATION OF THREE DIMENSIONAL TOOL FRAME

(71) Applicant: General Electric Company, Schenectady, NY (US)

(72) Inventors: Anna Ewa Swieca, Blonie (PL); Dariusz Zybura, Warsaw (PL); Lukasz Sajdak, Rusiec (PL)

(21) Appl. No.: 17/169,663

(22) Filed: Feb. 8, 2021

(30) Foreign Application Priority Data
Jan. 8, 2021 (PL) P.436620

(51) Int. Cl. B25J 9/16

(52) U.S. Cl. CPC B25J 9/1697; B25J 9/1669; B25J 9/1671

(57) ABSTRACT

Embodiments of the disclosure include a method to create a three-dimensional (3D) tool frame for a robot. The method includes identifying a reference point on a calibration grid using a robotic vision system, such as a camera or laser. The identified reference point is used to create a user frame coordinate system with an origin at the identified reference point. The identified reference point being equal to a field of view origin created by a 3D scanner. Being at the specific location where the field of view origin is created during calibration, a 3D tool frame is created based on user frame location. The 3D tool frame indicates the location and orientation of the 3D scanner in the field of view coordinate system.

### FIELD OF INVENTION

Embodiments of the claimed invention relate generally to scanning physical objects with robotic vision sensors, and more particularly, to methods and devices for creating a three-dimensional (3D) tool frame in a field of view coordinate system origin.

### BACKGROUND

Three-dimensional (3D) scanning is the process of analyzing a 3D real-world object or environment to collect data on its dimensions and/or appearance. Collected data can be used to construct digital 3D models. A 3D scanner implements a 3D scanning process based on one or more different technologies (e.g., 3D structured-light scanners). For example, 3D structured-light scanners measure the 3D characteristics of an object using projected light patterns and a camera system. A directional scans merging process combines two or more data sets (e.g., scans) obtained using a 3D scanner to construct a digital representation of a physical object based on geometric features measured at two or more position registers (e.g., location and orientation of the 3D scanner with respect to the physical object(s) being analyzed). Generally, operators must calibrate a 3D scanner before use.

3D scanning typically relies on a frame of reference (also referred to as a “frame” or a “reference frame”) that includes a coordinate system, such as a Cartesian coordinate system. A Cartesian coordinate system is a coordinate system that specifies each point uniquely in a 3D space along three mutually perpendicular planes. During industrial robotic arms (referred to as a “robot”) programming there are three types of frames typically used: (1) a global frame, (2) a tool frame, and/or (3) a user frame. A global frame uses a 3D Cartesian coordinate system with an origin (i.e., zero coordinate on all axes) typically attached to the base of a robot. A tool frame uses a 3D Cartesian coordinate system with an origin that is typically at the end of a tool mounted on a surface of a robot (e.g., mounted on a flange of a robotic arm). Cartesian coordinates with an origin at the center of a tool-mounting surface of a robot are referred to as mechanical interface coordinates. Generally, based on the origin of the mechanical interface coordinates, tool coordinates (of a tool frame) define the offset distance of components and axis rotation angles. A user frame consists of Cartesian coordinates defined for each operation space of an object. User frame coordinates are expressed in reference to global frame coordinates of a global frame coordinate system—i.e., (X, Y, Z).

### BRIEF SUMMARY

Aspects of the disclosure include a method of creating a three-dimensional (3D) tool frame, the method including identifying a reference point positioned on, or proximate to, a reference component (calibration grid). A creating step creates a user frame having a user frame origin at the reference point. Another creating step creates a 3D tool frame at a position register relative to the reference component.

Further aspects of the disclosure include a robotic device to create a three-dimensional (3D) tool frame, the robotic device including a robotic arm, a robotic vision system, and a robotic controller. The robotic vision system is configured to identify a reference point positioned on, or proximate to, a reference component. The robotic controller is configured to manipulate the location and orientation of the robotic arm in a global frame. The robotic controller including a robotic processor configured to create a 3D tool frame based, at least in part, on the reference point.

Still further aspects of the disclosure include a method of creating a three-dimensional (3D) tool frame, the method including identifying a reference point positioned on, or proximate to, a reference component. Identifying a position register in a global frame, the position register including the location a scanner creates a field of view coordinate system having a field of view origin. Creating a user frame having a user frame origin at the identified reference point. Creating a 3D tool frame based, at least in part, on the position register and the user frame origin.

### BRIEF DESCRIPTION OF THE DRAWINGS

The drawings illustrate embodiments presently contemplated for carrying out the invention. In the drawings:

FIG. 1 is a plan view of a robotic device for generating a tool frame.

FIG. 2A is a front view of a reference component for creating a user frame.

FIG. 2B is a perspective view of a reference component and a robotic device to create a user frame.

FIG. 3 is a plan view of a robotic device creating a field of view origin at a position register.

FIG. 4 shows a schematic view of an illustrative environment for deploying a controller for a robotic device according to embodiments of the disclosure.

FIG. 5 depicts a perspective view of a robotic device configured to generate a tool frame.

FIG. 6 is an illustrative flow diagram of a method to generate a tool frame using a robotic device.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

Embodiments of the disclosure include a method and device for the creation of a three-dimensional (3D) tool frame. A robot may use a 3D tool frame to position and orient a robotic component to achieve one or more tasks based on the functionality of the component. The robotic component may include, for example, a robotic vision system. A robotic vision system uses one or more sensors (e.g., cameras, lasers) to identify the location and orientation of one or more objects in a field of view. A field of view is a region proximate to a robotic component, and one or more physical objects within the region (i.e., within the field of view) will be identified by the robotic component. The robotic component may include, for example, a robotic scanner. A robotic scanner is a robotic component that uses one or more sensors (e.g., structured light projection) to identify geometric features of one or more objects in a field of view. A robotic scanner may inspect a physical object by, for example, creating a digital representation of the physical object to ascertain the structural integrity of the physical object. Typically, before inspecting a physical object, an operator of a robot manually generates a user frame, manually creates a 3D tool frame for a robotic scanner, and manually calibrates the robotic scanner. These steps expend significant time.

In some embodiments, creating a 3D tool frame includes using a generated user frame to determine the location of a 3D tool frame origin in a global frame. Generating a user frame may include using a robotic controller to move a robotic vision system to one or more specific positions (i.e., location and orientation in a global frame) such that a reference component (e.g., a calibration grid) is at least partially in the robotic vision system field of view. The robotic vision system may identify one or more reference points on, or proximate to, the reference component. The generated user frame may be a coordinate system having a user frame origin (i.e., point at which all coordinate values are zero) positioned on, or proximate to, a reference component. A user frame origin may be at an identified reference point positioned on, or proximate to, the reference component. A user frame origin may have coordinates equal, or substantially similar, to coordinates of a 3D tool frame origin in a global frame.

In some embodiments, calibrating a robotic scanner includes using a robotic controller to move a robotic scanner to a plurality of position registers (i.e., location and orientation in a global frame) and using the robotic scanner to measure geometric features of objects within a field of view at each position register. At a position register, of the plurality of position registers, the robotic scanner measures a field of view. Being in the same position register, the robotic scanner may generate a field of view coordinate system that includes a field of view origin. The field of view origin may have coordinates equal, or substantially similar, to coordinates of a user frame origin in a global frame.

In some embodiments, creating a 3D tool frame may include identifying the location and orientation of a robotic scanner, in a global frame, upon creation of a field of view origin. The robotic scanner may create a field of view origin at a specific position register (i.e., location and orientation in a global frame) during a calibration process. The field of view origin may have coordinates equal, or substantially similar, to coordinates of a user frame origin in a global frame. The user frame origin may be positioned on, or proximate to, a reference component. The reference component may be, for example, a calibration grid. Creating a 3D tool frame may occur during a calibration process of a robotic scanner. For example, while in a known position register, a robotic scanner measures a field of view and generates a field of view coordinate system having a field of view origin. A reference component, such as a calibration grid, is within the field of view of the robotic scanner. A reference point positioned on, or proximate to, the reference component is within the field of view. The reference point having coordinates, in a global frame, equal to coordinates of a user frame origin of a generated user frame positioned on, or proximate to, the reference component. Coordinates of the user frame origin are equal, or substantially similar, to coordinates of the field of view origin in a global frame. The robotic scanner creates a 3D tool frame based on the location and orientation of the robotic scanner with respect to the user frame origin.

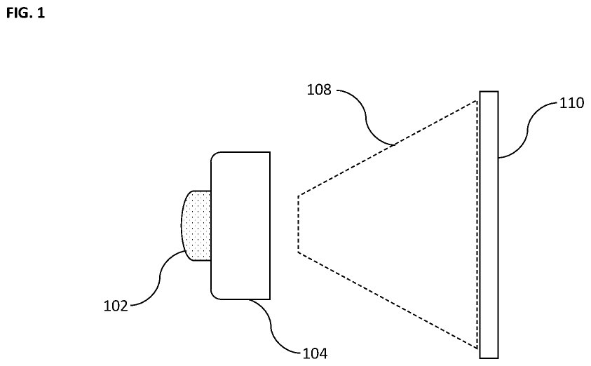

FIG. 1 depicts a plan view of a robotic device configured to generate a tool frame. In an example, a robot 102 positions a robotic scanner 104 relative to a reference component 110. Robot 102 may include one or more robotic components (e.g., actuators, motors, stepper motors, power source, motor driver, robotic controller, etc.) to manipulate the location and orientation of robot 102, or items coupled to robot 102, in a global frame. In an example, robot 102 is a robotic arm capable of moving a robotic scanner 104 in a global frame relative to a reference component 110. Robotic scanner 104 may include one or more robotic components (e.g., a structured light projection source, cameras, lasers, etc.) to measure a field of view 108. Robotic scanner 104 may be capable of identifying various geometric features within field of view 108. Field of view 108 may depend on the location and orientation of robotic scanner 104 in a global frame. Robot 102 may position robotic scanner 104 such that reference component 110 is at least partially within field of view 108. Reference component 110 may include, for example, a calibration grid. In an example, reference component 110 includes a calibration grid with markers for calibrating robotic scanner 104 in preparation for inspecting a physical object (e.g., inspecting a manufactured component for structural integrity). In further implementations, robotic scanner 104 creates a field of view coordinate system having a field of view origin at a specific location and orientation within a global frame (e.g., at a specific position register). Robot 102 and robotic scanner 104 may be referred to as a robotic vision system.

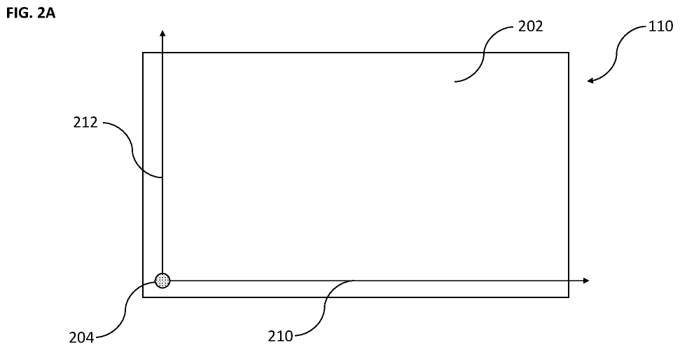

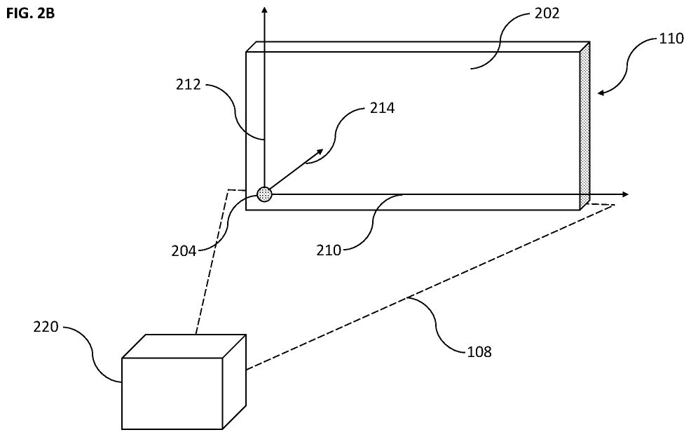

FIG. 2A depicts a front view of reference component for creating a user frame. In the present embodiment, reference component 110 of FIG. 2A is a rectangular calibration grid with a front reference surface 202. Reference component 110 may include a reference point 204 positioned on, or proximate to, front reference surface 202. Reference point 204 may be identified using a robotic vision system (not shown). Reference point 204 may enable a robotic vision system to generate a user frame positioned on, or proximate to, front reference surface 202. A generated user frame is a coordinate system that may include reference point 204, first axis 210, and/or second axis 212. The origin of the generated user frame may be located at reference point 204 or in any other location on, or proximate to, front reference surface 202. The origin of the generated user frame (e.g., reference point 204) may be based, at least partially, on a field of view coordinate system origin (not shown). First axis 210 extends from reference point 204 along, or proximate to, front reference surface 202. Second axis 212 extends from reference point 204 along, or proximate to, front reference surface 202 and perpendicular to first axis 210.

FIG. 2B depicts a perspective view of a reference component and a robotic vision system for creating a user frame. In the present embodiment, the reference component 110 of FIG. 2B includes an identical, or substantially similar, configuration and functionality as described in FIG. 2A. Additionally, the user frame (as described in FIG. 2A) includes a third axis 214 extending from reference point 204. Third axis 214 is perpendicular to first axis 210 and second axis 212. Robotic vision system 220 may measure a field of view 108 and identify reference point 204 within field of view 108. Robotic vision system 220 may include, for example, a camera or laser component to identify the location of reference point 204 to generate a user frame. The generated user frame may include first axis 210, second axis 212, and/or third axis 214. The generated user frame may include an origin (i.e., point at which all coordinate values are zero) at reference point 204. Robotic vision system 220 may identify coordinates of reference point 204 in a global frame. Robotic vision system 220 may be communicatively coupled to and/or operatively associated with another component. In further implementations, robotic vision system 220 may identify more than one reference point to generate a user frame.

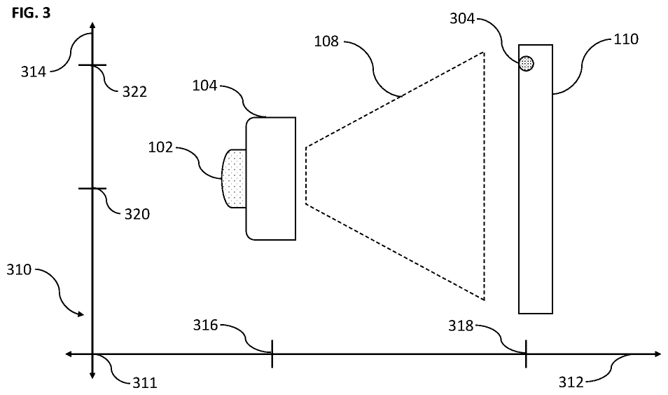

FIG. 3 depicts a plan view of a robotic device creating a field of view origin at a position register. In the present embodiment, a robot 102 positions a robotic scanner 104 relative to a reference component 110 in a global frame 310. Global frame 310 may include an x-axis 312, a y-axis 314, a z-axis (not shown), and a global frame origin 311 (i.e., at the intersection of the x, y and z axes). X-axis 312 may include a first x-axis point 316 (X₁) and a second x-axis point 318 (X₂). Y-axis 314 may include a first y-axis point 320 (Y₁) and a second y-axis point 322 (Y₂). Robot 102 may position robotic scanner 104 at one or more position registers in global frame 310 (i.e., one or more specified coordinates in global frame 310). Robotic scanner 104, while in a specific position register, may create a field of view origin 304. In the present embodiment, robot 102 and robotic scanner 104 are at a position register having coordinates of (X₁, Y₁) in global frame 310—i.e., at first x-axis point 316 and first y-axis point 320. While positioned at coordinates (X₁, Y₁) in global frame 310, robotic scanner 104 creates field of view origin 304 at coordinates (X₂, Y₂) in global frame 310—i.e., at second x-axis point 318 and second y-axis point 322.

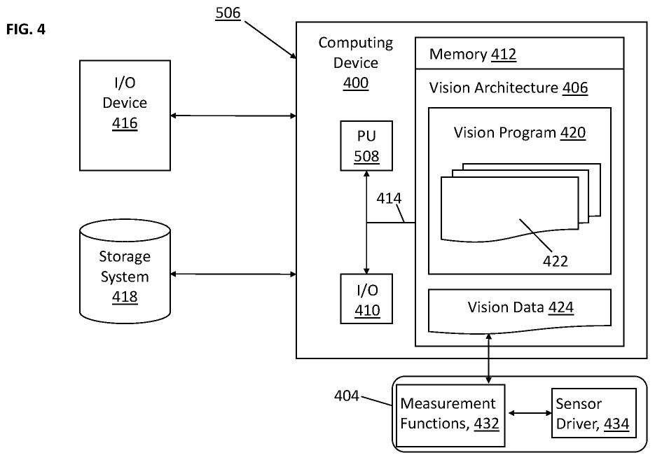

Turning to FIG. 4, the present disclosure can include one or more controllers 506 included within and/or communicatively connected to a robotic vision system for executing processes to create a 3D tool frame. To further illustrate the operational features and details of controller 506, an illustrative embodiment of a computing device 400 is discussed herein. Controller 506, computing device 400, and sub-components thereof are illustrated with a simplified depiction to demonstrate the role and functionality of each component. In particular, controller 506 can include computing device 400, which in turn can include vision architecture 406. The configuration shown in FIG. 4 is one embodiment of a system for reading, transmitting, interpreting, etc., data for creating a 3D tool frame. As discussed herein, computing device 400 can analyze the various readings by sensor(s) 404 to read or interpret vision data 424 within a measured field of view. Furthermore, embodiments of the present disclosure can perform these functions automatically and/or responsive to user input by way of an application accessible to a user or other computing device. Such an application may, e.g., provide the functionality discussed herein and/or can combine embodiments of the present disclosure with a system, application, etc., for remotely controlling a robotic device configured to create a 3D tool frame. Embodiments of the present disclosure may be configured or operated in part by a technician, computing device 400, and/or a combination of a technician and computing device 400. It is understood that some of the various components shown in FIG. 4 can be implemented independently, combined, and/or stored in memory for one or more separate computing devices that are included in computing device 400. Further, it is understood that some of the components and/or functionality may not be implemented, or additional schemas and/or functionality may be included as part of vision architecture 406.

Computing device 400 can include a processor unit (PU) 508, an input/output (I/O) interface 410, a memory 412, and a bus 414. Further, computing device 400 is shown in communication with an external I/O device 416 and a storage system 418. External I/O device 416 may be embodied as any component for allowing user interaction with controller 506. Vision architecture 406 can execute a vision program 420, which in turn can include various modules 422, e.g., one or more software components configured to perform different actions, including without limitation: a calculator, a determinator, a comparator, etc. Modules 422 can implement any currently known or later developed analysis technique for recording and/or interpreting various measurements to provide data. As shown, computing device 400 may be in communication with one or more sensor(s) 404 for measuring and interpreting vision data 424 of a field of view.

Modules 422 of vision program 420 can use algorithm-based calculations, look up tables, and similar tools stored in memory 412 for processing, analyzing, and operating on data to perform their respective functions. In general, PU 508 can execute computer program code to run software, such as vision architecture 406, which can be stored in memory 412 and/or storage system 418. While executing computer program code, PU 508 can read and/or write data to or from memory 412, storage system 418, and/or I/O interface 410. Bus 414 can provide a communications link between each of the components in computing device 400. I/O device 416 can comprise any device that enables a user to interact with computing device 400 or any device that enables computing device 400 to communicate with the equipment described herein and/or other computing devices. I/O device 416 (including but not limited to keyboards, displaying, pointing devices, etc.) can couple to controller 506 either directly or through intervening I/O controllers (not shown).

Memory 412 can also store various forms of vision data 424 pertaining to a measured field of view where a robotic device, robot, robotic scanner, robotic vision system, and/or computing device 400 are deployed. As discussed elsewhere herein, computing device 400 can measure, interpret, etc., various measurements by and/or inputs to sensor 404 to be recorded as vision data 424. Vision data 424 can also include one or more fields of identifying information for each measurement, e.g., a time stamp, serial number of sensor(s) 404, time interval for each measurement, etc. Vision data 424 can thereafter be provided for transmission to a remote location. To exchange data between computing device 400 and sensor 404, computing device 400 can be in communication with sensor(s) 404 through any currently known or later developed type of electrical communications architecture, including wired and/or wireless electrical couplings through a circuit board. To create a 3D tool frame, vision program 420 of vision architecture 406 can store and interact with vision data 424 according to processes of the present disclosure.

Vision data 424 can optionally be organized into a group of fields. For example, vision data 424 can include fields for storing respective measurements, e.g., location and orientation of a robotic vision system in a global frame, location of a reference point in a global frame, location and orientation of a reference component in a global frame, etc. Vision data 424 can also include calculated or predetermined referenced values for each field. For instance, vision data 424 can include the location and orientation of a robotic vision system in a global frame (e.g., a specific position register) at which a field of view origin is created. Vision data 424 can also include values measured using one or more sensor(s) 404, such as a robotic scanner. Each form of vision data 424 can be indexed relative to time such that a user can cross-reference various forms of vision data 424. It is understood that vision data 424 can include other data fields and/or other types of data therein for creating a 3D tool frame as described herein.

Vision data 424 can also be subject to preliminary processing by modules 422 of vision program 420 before being recorded in memory 412. For example, one or more modules 422 can apply a set of rules to interpret inputs from sensor(s) 404 to facilitate the creation of a 3D tool frame. Such rules and/or other criteria may be generated from predetermined data and/or relationships between various quantities. For example, an operator may determine that a robotic vision system creates a field of view origin at a specified position register proximate to the origin of a global frame, a sensor 404 (e.g., robotic scanner) measures a field of view and a 3D tool frame is created while at the specified position register.

Computing device 400 can comprise any general purpose computing article of manufacture for executing computer program code installed by a user (e.g., a personal computer, server, handheld device, etc.). However, it is understood that computing device 400 is only representative of various possible equivalent computing devices that may perform the various process steps of the disclosure. In addition, computing device 400 can be part of a larger system architecture. In addition, sensor 404 can include one or more sub-components configured to communicate with controller 506 to provide various inputs. In particular, sensor 404 can include one or more measurement functions 432 electrically driven by a sensor driver 434 included in sensor 404 to, for example, measure geometric features (e.g., vision data 424) within a field of view. In an example embodiment, sensor 404 is a robotic scanner configured to measure a field of view using structured light projection. In further implementations, sensor 404 may include one or more cameras, lasers, etc., to measure geometric features within a field of view. Measurement functions 432 can thereafter communicate recorded data (e.g., a measured field of view, time measurement, location, orientation, etc.) to vision architecture for storage or analysis. In some instances, it is understood that sensor driver 434 may include or otherwise be in communication with a power source (not shown) for electrically driving operation.

To this extent, in other embodiments, computing device 400 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. In one embodiment, computing device 400 may include a program product stored on a computer readable storage device, which can be operative to create a 3D tool frame or operate a robotic vision system.

In embodiments where sensor(s) 404 include a robotic scanner (e.g., camera, laser, structured light projection, etc.), sensor(s) 404 can include additional features and/or operational characteristics to create a 3D tool frame based on vision-related data. In an embodiment, sensor(s) 404 in the form of a robotic scanner couple to a robotic arm to measure a field of view and create a 3D tool frame at a specified position register in a global frame. In such cases, controller 506 commands robotic components (e.g., actuators, motors, etc.) to manipulate the location and orientation of a robotic arm and, thus, manipulate the robotic scanner in a global frame. The vision-related data (e.g., vision data 424) collected with sensor(s) 404 can enable the creation of a 3D tool frame while at a specific position register in a global frame.

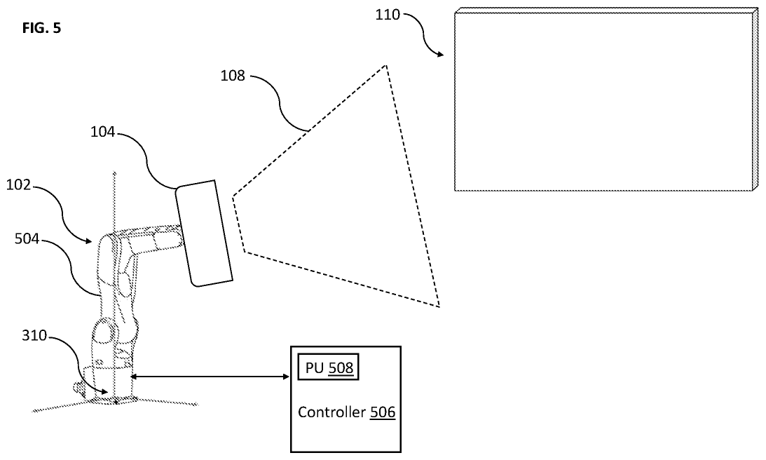

FIG. 5 depicts a perspective view of a robotic device configured to generate a tool frame. In an example, a robot 102 positions a robotic scanner 104 relative to a reference component 110. Robot 102 may include a robotic arm 104 for positioning robotic scanner 104 such that reference component 110 is at least partially within a field of view 108. Robotic arm 104 may include a controller 506 having a processing unit (PU) 508. Controller 506 may include a process to manipulate the location and orientation of robotic arm 104 in a global frame 310. PU 508 may be electrically coupled to a robotic vision system (e.g., robot 102 and robotic scanner 104, collectively). PU 508 may produce signals to implement a process stored in memory as part of a program (e.g., a process stored in memory 412 as part of vision program 420) to create a 3D tool frame.

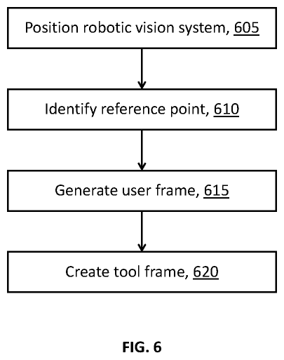

FIG. 6 depicts an illustrative flow diagram of a method to generate a tool frame using a robotic vision system. In the present embodiment, the method may include a process step 605 of positioning a robotic vision system at a first position register (i.e., a first location and orientation in a global frame). The robotic vision system may have a first field of view at the first position register, where the first field of view includes, at least partially, a reference component. Process step 605 may include a robotic scanner positioned on, or proximate to, a surface of a robot (e.g., a flange of a robotic arm). A robotic controller may issue commands to manipulate the location and orientation of the robotic vision system using vision program 420 of FIG. 4. In the present embodiment, process step 605 includes using a tool changer device to couple a robotic scanner to a surface of a robot. Alternatively, a robotic scanner is permanently coupled, or integrated, to a robot or robotic component.

Identifying a reference point in process step 610 may include using the robotic vision system of step 605 to measure coordinates of a specific point (i.e., a reference point at (X, Y, Z) coordinates) in a global frame. The reference point positioned on, or proximate to, a surface of a reference component. Process step 610 may include using controller 506 and vision program 420 to direct a robotic vision system to identify a reference point within a field of view. In this example, a reference component may be a rectangular calibration grid and the reference point positioned on, or proximate to, a corner of the reference component. Alternatively, a reference component may include a calibration grid of different geometric configurations (i.e., the reference component may not be rectangular and could, for example, be of any conceivable geometry (e.g., spherical, pyramidal, composite, and/or other types of shapes)). As a further alternative embodiment, identifying a reference point in step 610 may include identifying two or more reference points positioned on, or proximate to, a surface of a reference component (i.e., three reference points positioned on a calibration grid).

Generating a user frame in process step 615 may include using the robotic vision system of process step 605 to create a coordinate system (e.g., a user frame) based, at least in part, on the identified reference point of process step 610. Process step 615 may include a user frame origin (i.e., a point at which all coordinates are zero) at the identified reference point of process step 610. Process step 615 may include a user frame origin at the identified reference point of process step 610 that has coordinates equal, or substantially similar, to coordinates of a field of view origin in a global frame. The field of view origin may include the origin of a field of view coordinate system created by the robotic vision system during a calibration process at a specified position register. Process step 615 may include using vision program 420 to process vision data 424 obtained by the robotic vision system, such as the identified reference point of process step 610. In an example, the generated user frame is a three-dimensional (3D) coordinate system. Such a system includes a first axis extending along, or proximate to, a first edge of a reference component; a second axis extending along, or proximate to, a second edge of the reference component; and a third axis extending along, or proximate to, a third edge of the reference component.

Creating a tool frame in process step 620 may include using a controller 506 to direct a robotic visions system to move to at least one position register (i.e., location and orientation in a global frame). Process step 620 may include using the user frame yielded in process step 615 and a position register to create a 3D tool frame. Process step 620 may include a specified position register where a robotic vision system creates a field of view origin. Process step 620 may include creating a 3D tool frame after a robotic scanner creates a field of view origin at a position register, but before moving the robotic scanner from the position register. Process step 620 may include creating a 3D tool frame having a 3D tool frame origin that is equal, or substantially similar to, a field of view origin created by a robotic scanner. Process step 620 may include creating a 3D tool frame having a 3D tool frame origin that is equal, or substantially similar, to the created user frame origin yielded in process step 615. Process step 620 may include using vision program 420 (or, additionally, vision modules 422) to process the created user frame origin yielded in process step 615 to create a 3D tool frame.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangement not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method of creating a three-dimensional (3D) tool frame, the method comprising:
identifying a reference point positioned on, or proximate to, a reference component;
creating a user frame having a user frame origin at the reference point; and
creating a 3D tool frame at a position register relative to the reference component.

2. The method of claim 1, wherein creating the 3D tool frame includes a 3D tool frame origin, the 3D tool frame origin having coordinates substantially similar to coordinates of the user frame origin in a global frame.

3. The method of claim 1, identifying the reference point further comprising:
positioning a robotic vision system such that the reference component is within a field of view of the robotic vision system, wherein the reference component is a calibration grid; and
identifying coordinates of the reference point in a global frame using the robotic vision system.

4. The method of claim 1, creating the 3D tool frame further comprising:
identifying coordinates of a field of view origin in a global frame, wherein coordinates of the field of view origin are substantially similar to coordinates of the reference point in the global frame.

5. The method of claim 1, wherein creating the user frame includes at least a first axis and a second axis extending from the user frame origin, the first axis perpendicular to the second axis.

6. The method of claim 1, wherein creating the 3D tool frame includes identifying coordinates of the position register in a global frame, wherein the position register includes the location at which a scanner creates a field of view origin.

7. The method of claim 3, wherein positioning the robotic vision system includes using a robotic controller to manipulate the location and orientation of the robotic vision system in a global frame.

8. The method of claim 7, wherein positioning the robotic vision system includes using the robotic controller to manipulate the location and orientation of a robotic arm in the global frame, wherein the robotic vision system couples to a surface of the robotic arm.

9. A robotic device to create a three-dimensional (3D) tool frame, the robotic device comprising:
a robotic arm;
a robotic vision system coupled to the robotic arm, the robotic vision system configured to identify a reference point positioned on, or proximate to, a reference component; and
a robotic controller configured to manipulate the location and orientation of the robotic arm in a global frame, the robotic controller comprising:
a robotic processor electrically coupled to the robotic vision system, the robotic processor configured to create a 3D tool frame based, at least in part, on the reference point.

10. The robotic device of claim 9, wherein the robotic controller positions the robotic arm at a position register, the position register including the location in the global frame that a robotic scanner creates a field of view origin.

11. The robotic device of claim 10, wherein the robotic processor creates the 3D tool frame when the robotic vision system is in the position register.

12. The robotic device of claim 9, wherein the robotic vision system determines coordinates of the reference point in the global frame, the reference point having equal, or substantially similar, coordinates as a field of view origin created by a robotic scanner.

13. The robotic device of claim 9, wherein the robotic processor creates the 3D tool frame having a 3D tool frame origin with equal, or substantially similar, coordinates as the reference point in the global frame, wherein the reference point is the origin of a user frame positioned on, or proximate to, the reference component.

14. A method of creating a three-dimensional (3D) tool frame, the method comprising:
identifying a reference point positioned on, or proximate to, a reference component;
identifying a position register in a global frame, the position register includes the location of a scanner when the scanner creates a field of view coordinate system having a field of view origin;
creating a user frame having a user frame origin at the reference point; and
creating a 3D tool frame based, at least in part, on the position register and the user frame origin.

15. The method of claim 14, wherein creating the 3D tool frame includes a 3D tool frame origin having substantially similar coordinates as the user frame origin in the global frame.

16. The method of claim 14, wherein identifying the reference point includes determining coordinates of the reference point in the global frame using a robotic vision system.

17. The method of claim 14, wherein creating the 3D tool frame occurs during a calibration process that includes positioning the scanner at the position register, wherein the 3D tool frame is created at the position register.

18. The method of claim 14, identifying the reference point further comprising:
positioning a robotic vision system such that the reference component is within a field of view of the robotic vision system,
wherein positioning the robotic vision system includes using a robotic controller to manipulate the location and orientation of the robotic vision system.

19. The method of claim 18, wherein positioning the robotic vision system includes using the robotic controller to manipulate a robotic arm coupled to the robotic vision system.

20. The method of claim 14, the method further comprising:
inspecting a physical object with the scanner to measure geometric features of the physical object,
wherein the scanner uses the created 3D tool frame to indicate the location and orientation of the scanner in the field of view coordinate system.
